(19) United States
(12) Patent Application Publication
(10) Pub. No.: US 2006/0244379 A1
(43) Pub. Date: Nov. 2, 2006

(54) PLASMA DISPLAY PANEL, METHOD OF MANUFACTURING THE SAME, AND COMPOSITION OF PARTITIONS THEREOF

(75) Inventor: Jung Chul Shin, Yeongdeungpo-gu, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/380,588

(22) Filed: Apr. 27, 2006

(30) Foreign Application Priority Data
Apr. 29, 2005 (KR) 10-2005-0036031

(51) Int. Cl. H01J 17/49

(52) U.S. Cl. 313/582

(57) ABSTRACT

A plasma display panel includes an upper plate having a sustain electrode, a lower plate having an address electrode, and a partition formed between the upper plate and the lower plate and having an inorganic ion exchanger. The yellow discoloration of the partition is prevented to improve color brightness and light permeability.

This application claims the benefit of Korean Patent Application No. P2005-0036031, filed on Apr. 29, 2005, which is hereby incorporated by reference as if fully set forth herein.

### 1. BACKGROUND OF THE INVENTION

1. Field of the Invention

The present invention relates to a plasma display panel, and more particularly, to a plasma display panel in which discoloration into yellow color of partitions generated when forming electrodes is prevented, and a method of manufacturing the same.

2. Discussion of the Related Art

Generally, in a plasma display panel, partitions, formed between a front substrate and a rear substrate, separate respective unit cells.

The respective unit cells are filled with main discharging gas such as neon gas, helium gas, or a mixture of the neon gas, and the helium gas and inert gas containing a small amount of xenon gas. When electrical discharge is generated due to application of high frequency electric voltage, the inert gas generates vacuum ultraviolet rays to illuminate phosphor so that images are displayed. Since the above-described plasma display panel can be made thin and light in weight, the plasma display panel is standing in the spotlight as a next generation display device.

FIG. 1 is a schematic perspective view illustrating a conventional plasma display panel. As shown in FIG. 1, on a front glass 101 as a displaying surface, where an image is displayed, of a front substrate 100 of the conventional plasma display panel, a plurality of pairs of sustain electrodes, in which pairs of a scan electrode 102 and a sustain electrode 103 are formed, is arranged. In the rear substrate 110, a plurality of address electrodes 113 is arranged on a rear glass 111 to cross the plural pairs of the sustain electrodes, and the rear substrate 110 is coupled with the front substrate 100 in parallel while keeping a predetermined distance therebetween.

In the rear substrate 110, stripe type (or well type) partitions 112 are arranged to form a plurality electrically-discharging spaces, that is, electrically-discharging cells and keep the parallelism thereof. Moreover, a plurality of address electrodes 113 is disposed in parallel to the partitions to perform the address discharge and to generate vacuum ultraviolet rays. The upper surface of the rear substrate 110 is coated with R-, G-, and B-colored phosphor 114 for emitting visual radiation so as to display images when the address discharging is carried out. Between the address electrodes 113 and the phosphor 114, a lower dielectric material layer 115 is formed to protect the address electrodes 113.

The conventional plasma display panel having the above-described structure is manufactured by the process roughly including a glass fabricating process, a front substrate fabricating process, a rear substrate fabricating process, and an assembling process.

First, the process of fabricating the substrate includes a process of forming a scan electrode and a sustain electrode on the front glass, a process of forming an upper dielectric material layer for restricting electric current discharged by the scan electrode and the sustain electrode and for insulating between the pair of the electrodes, and a process of forming a vapor-deposition protective layer of magnesium oxide on the upper dielectric material layer to aid electrical discharge.

The rear substrate fabricating process includes a process of forming an address electrode on the rear glass, a process of forming a lower dielectric material layer for protecting the address electrode, a process of forming partitions on the upper side of the lower dielectric material layer to partition discharge cells, and a process of forming a phosphor layer between the partitions to emit visual radiation for displaying images.

However, the plasma display panel manufactured by the above-described process has shortcomings as follows.

In the conventional plasma display panel, although partitions containing a great deal of lead (Pb) are used, due to environmental pollution, use of material containing lead is strongly restricted. Thus, as a material substituting the lead, alkali metal oxides such as B₂O₃, BaO, and R₂O are used. However, in this case, the partitions are discolored into yellow color as will be described later.

In other words, during the process of forming the rear substrate, silver contained in the address electrodes is diffused to the partitions so that the yellow discoloration occurs. Namely, when the silver in the address electrodes is ionized and diffused to the partitions during the process of baking paste to form the partitions, silver ions (Ag⁺) react with alkali components such as sodium ions (Na₊) at the surfaces of the paste of the partitions so that the yellow discoloration occurs. Particularly, since the partitions containing unleaded material contain more of the alkali component such as sodium, the yellow discoloration is more serious. The diffusion of the silver ions as a reason of the yellow discoloration is further activated due to oxygen (O₂) around the electrodes as temperature is gradually increased. Temperature when the diffusion begins is about 200 degrees centigrade to 300 degrees centigrade, particularly the diffusion is further activated at 350 degrees centigrade to 400 degrees centigrade. The baking process of the partition paste or green sheet is generally carried out at 500 degrees centigrade to 600 degrees centigrade. Due to oxygen in air and temperature higher than 500 degrees centigrade, the diffusion of the silver ions is further activated, so that the yellow discoloration is generated due to surface plasma resonance.

Due to the yellow discoloration of the partitions, color temperature of white ray in the visual radiation being displayed on the front panel is deteriorated so that quality of images may be deteriorated and the external appearance of the panel may be also damaged.

### 2. SUMMARY OF THE INVENTION

Accordingly, present invention is directed to a plasma display panel, a method of manufacturing the same, and material for partitions of the plasma display panel that substantially obviate one or more problems due to limitations and disadvantages of the related art.

An object of the present invention is to provide a plasma display panel in which the yellow discoloration caused by diffusion of silver ions is prevented to improve color temperature of white ray and image quality, a method of manufacturing the same, and material for partitions of the plasma display panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel includes an upper plate having a sustain electrode, a lower plate having an address electrode, and a partition formed between the upper plate and the lower plate and having an inorganic ion exchanger.

In another aspect of the present invention, a method of manufacturing a plasma display panel includes the steps of (1) preparing a material for a partition including an inorganic powder having a weight ratio of 60% to 80% and a vehicle having a weight ratio of 20% to 40% and an inorganic ion exchanger having a weight ratio of 0.01% to 5%, and (2) forming the partition on a lower plate using the material for the partition.

In still another aspect of the present invention, a method of manufacturing a plasma display panel includes the steps of forming a partition including a glass having inorganic powder on a dielectric material of a lower plate, and forming a partition protective layer on the surface of the partition using a material including a solvent having a weight ratio of 80% to 95%, a binder having a weight ratio of 5% to 20%, a dispersant having a weight ratio of 0.1% to 1%, and an inorganic ion exchanger having a weight ratio of 0.01% to 5%.

In still another aspect of the present invention, a composition of a material for a partition of a plasma display panel comprises an inorganic powder having a weight ratio of 60% to 80%, a vehicle having a weight ratio of 20% to 40%, and an inorganic ion exchanger having a weight ratio of 0.01% to 5%.

It is to be understood that both the foregoing general description and the following detailed description of the present invention are exemplary and explanatory and are intended to provide further explanation of the invention as claimed.

### 3. BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic perspective view illustrating a conventional plasma display panel;

FIG. 2 is a sectional view schematically illustrating a rear substrate of a plasma display panel according to a first preferred embodiment of the present invention;

FIG. 3 is a sectional view schematically illustrating a rear substrate of a plasma display panel according to a second preferred embodiment of the present invention;

FIG. 4 is a view illustrating composition of material of partitions for the plasma display panel according to the preferred embodiment of the present invention;

FIG. 5 is a view illustrating composition of material of partition protection layers for the plasma display panel according to the preferred embodiment of the present invention; and

FIG. 6 is a flowchart illustrating a method of manufacturing a plasma display panel according to a first preferred embodiment of the present invention;

FIGS. 7A to 7J are views illustrating the method of manufacturing a plasma display panel according to the first preferred embodiment of the present invention;

FIG. 8 is a flowchart illustrating a method of manufacturing a plasma display panel according to a second preferred embodiment of the present invention; and

FIGS. 9A to 9K are views illustrating the method of manufacturing a plasma display panel according to the second preferred embodiment of the present invention.

### 4. DETAILED DESCRIPTION OF THE INVENTION

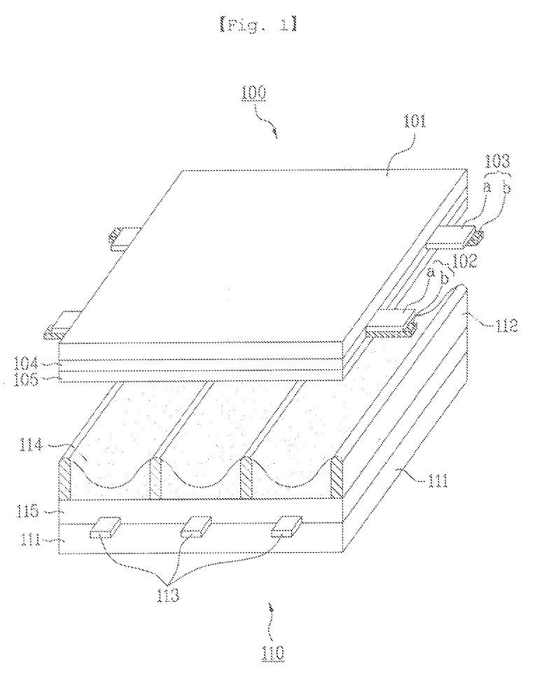

Reference will now be made in detail to the preferred embodiments of a plasma display panel, a method of manufacturing the same, and material for partitions of the plasma display panel of the present invention, examples of which are illustrated in FIGS. 1 to 9K.

FIG. 2 is a sectional view schematically illustrating a rear substrate of a plasma display panel according to a first preferred embodiment of the present invention.

A front substrate of a plasma display panel according to this preferred embodiment of the present invention has the same structure of that of the conventional plasma display panel such that a plurality of pairs of sustain electrodes in which pairs of a scan electrode and a sustain electrode are formed is arranged on a front glass 101 as a displaying surface, where an image is displayed, of a front substrate of the conventional plasma display panel. In a rear substrate, a plurality of address electrodes 113 is arranged on a rear glass 111 to cross the plural pairs of the sustain electrodes. A rear substrate 110 is coupled with the front substrate 100 in parallel while keeping a predetermined distance therebetween. The rear substrate is formed with partitions 112a to respectively define R-, G-, and B-discharge cells.

The partitions 112a contain inorganic ion exchangers. Preferably, the partitions 112a are characterized in that inorganic powder has a weight ratio of 95% to 99.99%, the inorganic ion exchangers have a weight ratio of 0.01% to 5%, and more preferably 0.1% to 5%. The inorganic powder contains glass with a weight of 50% to 70% and filler with a weight ratio of 30% to 50%. Preferably, the glass contains BiO₃, B₂O₃, SiO₂, Al₂O₃, SrO, BaO, Li₂O, Na₂O, K₂O, CuO, and CeO₂, wherein, preferably, BiO₃ has a weight ratio of 20% to 60%, B₂O₃ has a weight ratio of 20% to 55%, SiO₂ has a weight ratio of 0% to 15%, Al₂O₃ has a weight ratio of 0% to 15%, SrO has a weight ratio of 0% to 30%, BaO has a weight ratio of 0% to 30%, Li₂O has a weight ratio of 0% to 10%, Na₂O has a weight ratio of 0% to 10%, K₂O has a weight ratio of 0% to 10%, CuO has a weight ratio of 0% to 5%, and CeO₂ has a weight ratio of 0% to 5%. Although Na₂O contained in partitions without lead generates Na⁺ ions therefrom to cause the yellow discoloration, this element is necessary to reduce baking temperature and to adjust thermal expansion coefficient. Thus, in the present invention, the partitions contain the inorganic ion exchangers to reduce the quantity of Na⁺ ions that react with Ag⁺ ions.

The filler preferably contains Al₂O₃, TiO₂, PbO, and ZnO, and the contents of the elements are different from each other according to methods of forming the partitions. In other words, the quantities of Al₂O₃ and TiO are relatively much more when the partitions are developed by sanding method, and the quantities of PbO and ZnO are relatively much more when the partitions are developed by etching method. Further, the inorganic ion exchangers are selected from at least one of aluminosilicate, hydrous metal oxide, acid salt, heteropolyacid, Ca₁₀(PO₄)₆(OH)₂ and MgCl(CO₃) (OH).nH₂O. Preferably, aluminosilicate is zeolite, hydrous metal oxide is at least one of Sb₂O₅.2H₂O and Bi₂O₃.3H₂O, acid salt is at least one of Zr(HPO₄)₂.H₂O and Ti(HPO₄)₂.H₂O, and heteropolyacid is (NH₄)₃Mo₁₂ (PO₄)₄₀.nH₂O.

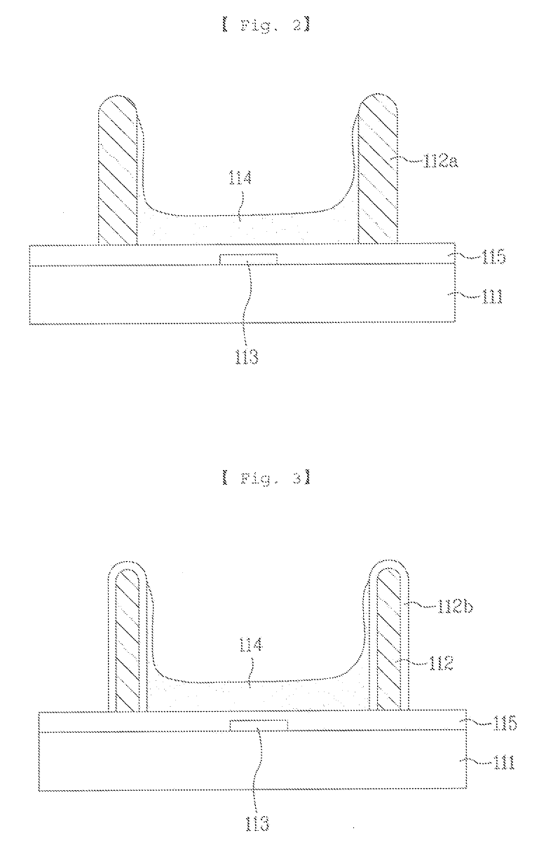

FIG. 3 is a sectional view schematically illustrating a rear substrate of a plasma display panel according to a second preferred embodiment of the present invention.

The plasma display panel according to this preferred embodiment is identical to the plasma display panel according to the first preferred embodiment of the present invention, and is different from the same in view that the inorganic exchangers contained in the partitions 112 form separate layers 112b. In other words, the partitions 112 are formed to contain the inorganic powder and the filler, and in the partitions 112 the inorganic exchangers 112b form the separate layer. Composition of the inorganic powder and the filler forming the partitions 112 is not significantly different from the composition of the inorganic powder and the filler in the first preferred embodiment of the present invention, but does not contain the inorganic ion exchangers. The inorganic ion exchangers 112b are separately formed in the form of layers formed in the surfaces of the partitions 112. Details for the inorganic exchangers such as kind of the inorganic ion exchangers are identical to those of the inorganic ion exchangers in the first preferred embodiment.

The plasma display panels including the partitions according to the first and the second preferred embodiments of the present invention further include the inorganic ion exchangers in the partitions or in the surfaces of the partitions. Thus, during the baking process of the partitions, the inorganic ion exchangers capture Na⁺ so that the quantity of Na⁺ to react with Ag⁺ is reduced. As a result, the quantity of Ag⁺ reduced to Ag⁰ decreases to prevent the yellow discoloration of the partitions so that color temperature of the white ray of the plasma display panel is improved and light permeability can be improved.

FIG. 4 is a view illustrating composition of material of partitions for the plasma display panel according to the preferred embodiment of the present invention.

Composition of material for the partitions of the plasma display panel according to this preferred embodiment of the present invention contains inorganic powder 400, vehicles 410, and inorganic ion exchangers 420. Preferably, the inorganic powder 400 has a weight ratio of 60% to 80%, the vehicles 410 have a weight ratio of 0% to 40%, and the inorganic ion exchangers 420 have a weight ratio of 0.01% to 5%. The inorganic powder 400 contains glass having a weight ratio of 50% to 70% and filler having a weight ratio of 30% to 40%. The glass contains Bi₂O₃, B₂O₃, SiO₂, Al₂O₃, SrO, BaO, Li₂O, Na₂O, K₂O, CuO, and CeO₂. The composition ratios of Bi₂O₃, and the others are identical to those of the plasma display panel according to the first preferred embodiment of the present invention. Moreover, the filler preferably contains Al₂O₃, TiO₂, PbO, and ZnO, and their respective contents are identical to those as described above even though the method of forming the partitions is different from the method of forming the partitions of the plasma display panel as described above.

The inorganic ion exchangers 420 are selected from at least one of aluminosilicate, hydrous metal oxide, acid salt, heteropolyacid, Ca₁₀(PO₄)₆(OH)₂ and MgCl(CO₃) (OH).nH₂O. Further, the details of compositions of the aluminosilicate, and the others are identical to those of the plasma display panel as described above. When the partitions are formed by sanding or etching, the vehicles 410 preferably contain binders such as ethyl cellulose or acryl and a solvent such as BCA or a-terpinol. When forming photosensitive partition paste, the vehicles 410 preferably contain binder polymer, monomer, oligomer, photo-initiator, and the like, and also contains at least one of plasticizer, leveling agent, UV absorber or dispersant.

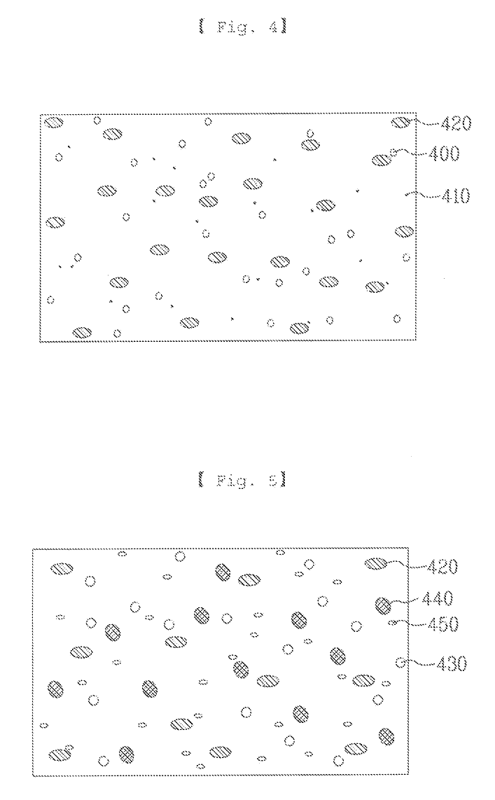

FIG. 5 is a view illustrating composition of material of partition protection layers for the plasma display panel according to the preferred embodiment of the present invention.

Composition of material for the partition protective layer of the plasma display panel according to this preferred embodiment of the present invention preferably includes solvents 430, binders 440, dispersants 450, and inorganic ion exchangers 420. In more detail, the solvents 430 have a weight ratio of 80% to 95%, the binders 440 have a weight ratio of 5% to 20%, the dispersants 450 have a weight ratio of 0.1% to 1%, and the inorganic ion exchangers have a weight ratio of 0.01% to 5%.

Composition of material for the partitions of the plasma display panel is a raw material for a paste or a green sheet used when the partitions are formed, and the composition of material for the partition protect layer is used when forming conventional partitions and after that forming protective layers on the partitions. Methods and operations of manufacturing the partitions and the protective layers will be described in detail later.

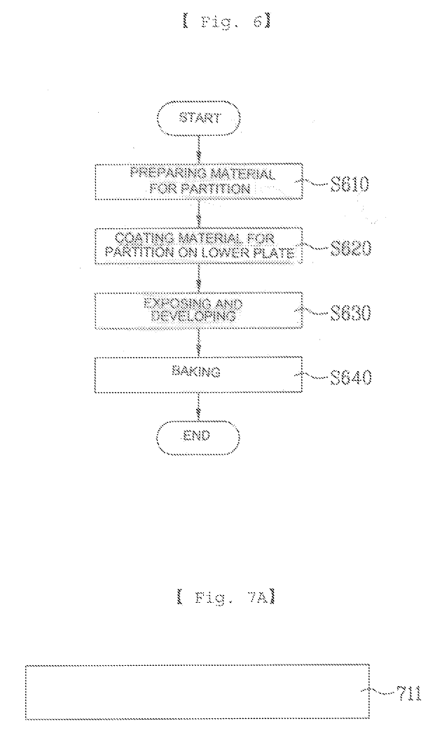

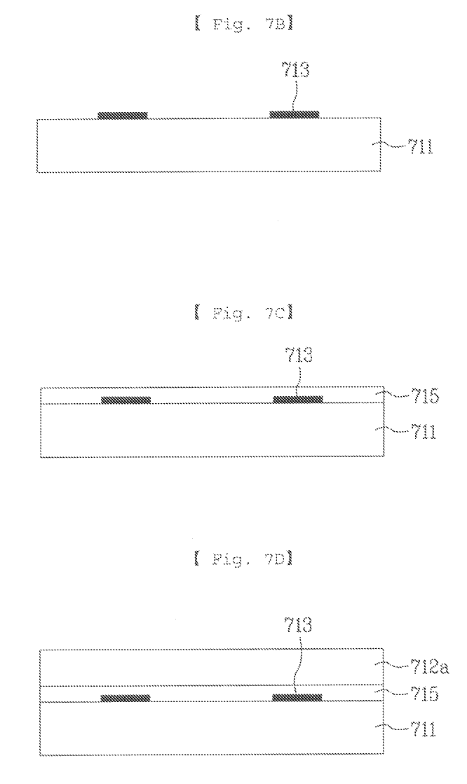

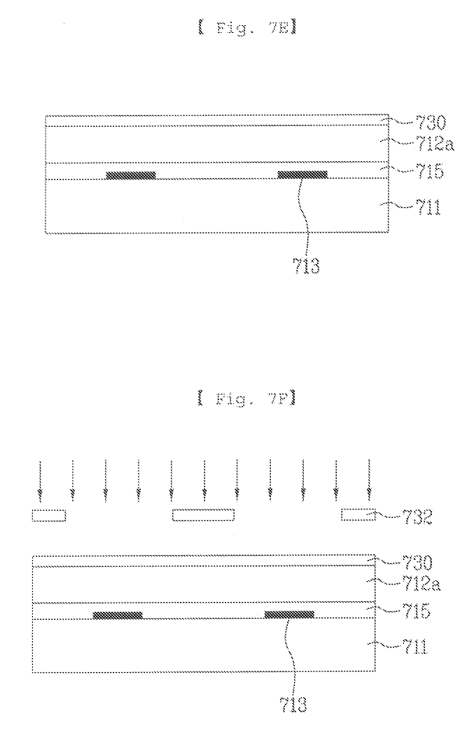

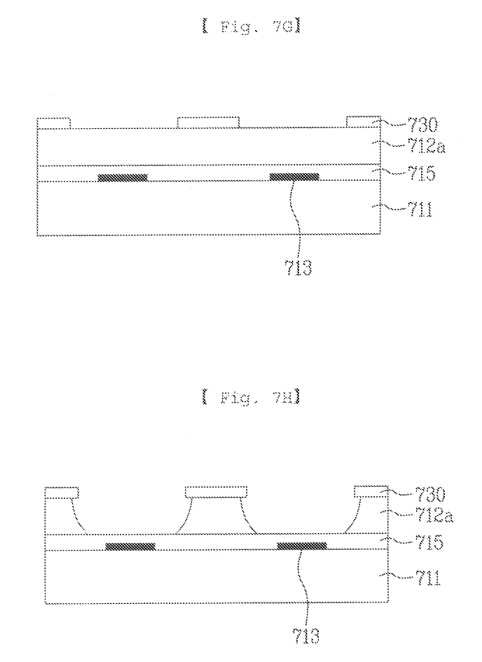

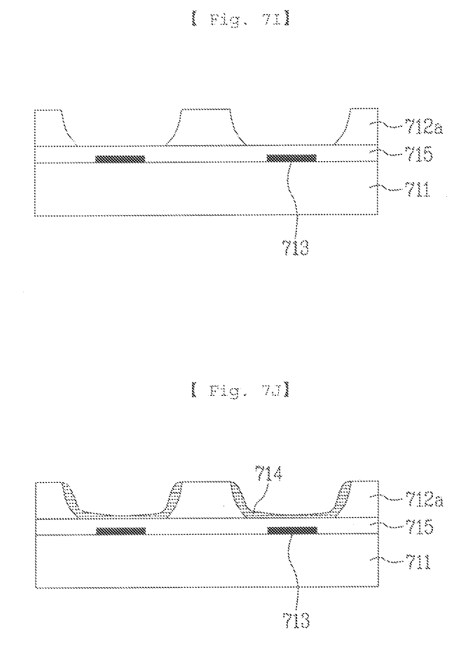

FIG. 6 is a flowchart illustrating a method of manufacturing a plasma display panel according to a first preferred embodiment of the present invention, and FIGS. 7A to 7J are views illustrating the method of manufacturing a plasma display panel according to the first preferred embodiment of the present invention.

A method of manufacturing a plasma display panel according to the first preferred embodiment of the present invention includes the steps of preparing material for the partitions containing inorganic powder, vehicles, and inorganic ion exchangers (S610) and forming the partitions in a lower plate using the material for the partitions (S620 to S640). Preferably, the inorganic powder has a weight ratio of 60% to 80%, the vehicles have a weight ratio of 20% to 40%, and the inorganic ion exchangers have a weight ratio of 0.01% to 5%, and more preferably, 0.1% to 5%. The components and compositions of the inorganic powder, the vehicles, and the inorganic ion exchangers are identical to those of the material for the partitions of the plasma display panel as described above.

The method of manufacturing a plasma display panel according to this preferred embodiment of the present invention will be described in detail as follows. In the process of manufacturing a rear substrate of the plasma display panel, as shown in FIG. 7A, a rear glass 711 is prepared, and preferably, the rear glass 711 is a soda-lime glass or PD200. Continuously, as shown in FIG. 7B, on the rear glass 711, an address electrode 713 is formed, and as shown in FIG. 7C, a lower dielectric material layer 715 is formed to cover the rear glass 711 and the address electrode 713. Moreover, partition 712a is formed on the lower dielectric material layer 715.

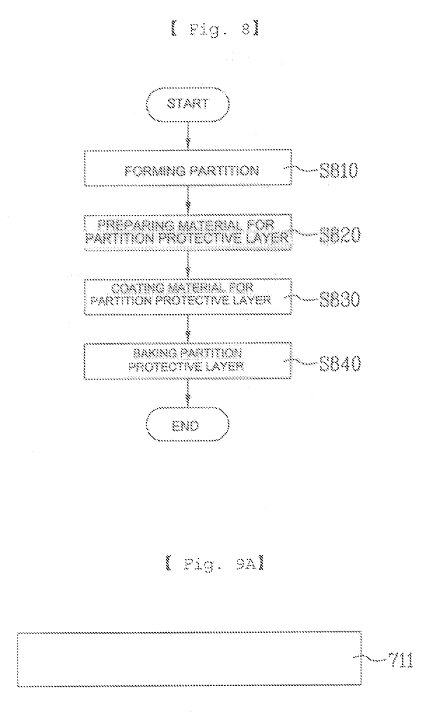

The process of forming the partition 712a will be described in detail as follows. Firstly, as shown in FIG. 7D, the material for the partition 712a is coated on the lower dielectric material layer 715 (S620). The coating of the material for the partition 712a is carried out by printing the material for the partition in the form of paste or laminating a partition green sheet in the form of slurry. The components and compositions of the material for the partition are identical to the components and compositions of the material for the partition of the plasma display panel as described above. Next, the coated material for the partition 712a is exposed by lithography to develop (S630), the lithography includes the steps of coating photo resist 730 on the material for the partition 712a as shown in FIG. 7E, of covering a photo mask on the upper side of the photo resist 730 as shown in FIG. 7F, and of projecting light to the photo resist 730 and hardening the photo resist 730. Continuously, as shown in FIG. 8g, in the development process, the photo resist 730 which is not hardened is washed away, and as shown in FIG. 7h, the material for the partition 712a illuminated by light is etched. Preferably, aqueous Na₂CO₃ solution or MEA (2-amino ethanol) is used as a developing solution. As shown in FIG. 7I, the photo resist 730 is removed and baked to complete the partition 712a (S640). The baking temperature is preferably 500 degrees centigrade to 600 degrees centigrade, and more preferably, 540 degrees centigrade to 560 degrees centigrade.

The method as described above is described as a method of coating the material for the partition and projecting light to the material for the partition to expose the material for the partition. However, when a photosensitive initiator is contained in the material for the partition, the photo mask is covered and exposed to the light without using the photo resist and the portion which is not exposed to the light is removed by the developing solution. In the sanding process, the photo resist is exposed to the light and developed and the portion in which the photo resist does not remain is removed by sanding. Moreover, in the etching process, the photo resist is exposed to the light and developed and etching liquid is sprayed to remove the portion in which the photo resist does not remain.

Next, as shown in FIG. 7J, phosphor 714 is coated on the upper side of the lower dielectric material layer 715 and on a side of the partition 712a to complete the lower substrate. The substrate manufactured by the above-described process is bonded to the front substrate having the address electrode using sealing material such as seal frit, and in more detail, the seal frit is baked and heated to discharge impurities existing in the seal frit. In order to increase plasma discharge efficiency within the discharge cells of the plasma display panel, inert gas such as helium gas He, Neon gas Ne, Xenon gas Xe, or the like is injected.

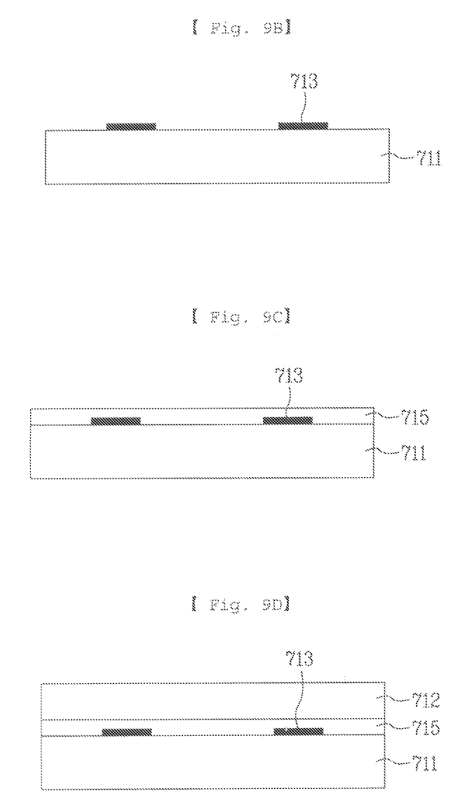

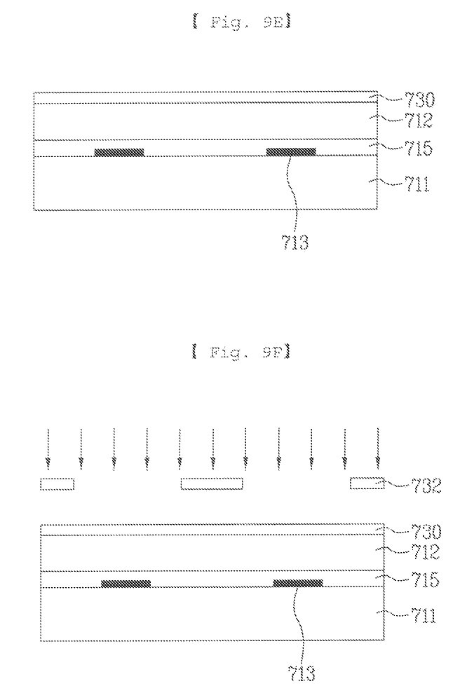

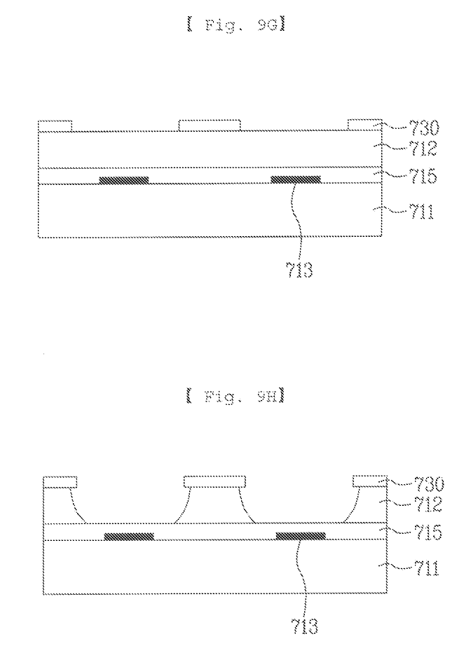

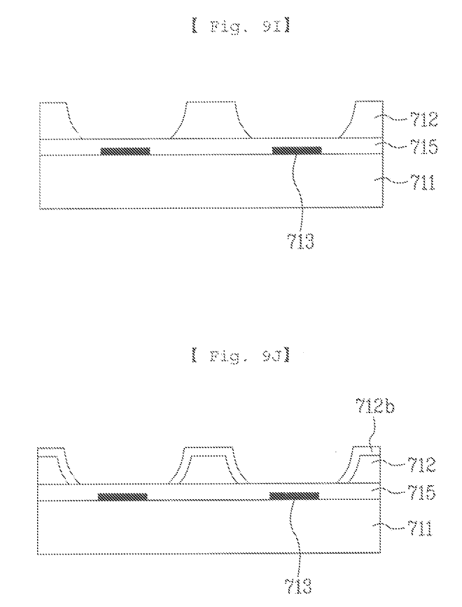

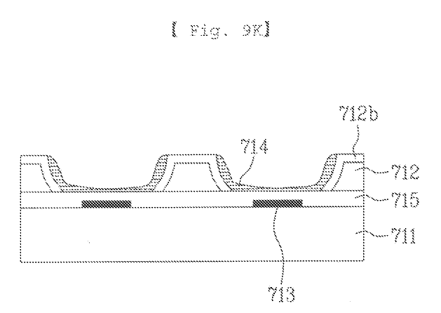

FIG. 8 is a flowchart illustrating a method of manufacturing a plasma display panel according to a second preferred embodiment of the present invention, and FIGS. 9A to 9K are views illustrating the method of manufacturing a plasma display panel according to the second preferred embodiment of the present invention.

Hereinafter, the method of manufacturing a plasma display panel according to the second preferred embodiment of the present invention will be described. The method according to this preferred embodiment of the present invention is different from the method according to the first preferred embodiment of the present invention in view of forming the partition having the same composition as the composition of the conventional partition (S810) and forming a separate partition protective layer (S820 to S840).

The detail thereof will be described as follows. Firstly, as shown in FIGS. 9A to 9I, on the lower glass 711, address electrodes 713 and a dielectric material layer 751 are formed, material for partitions is coated, the exposure process is carried out, and the developing process is carried out to form partitions 712. The components and the compositions of the material for the partitions are identical to those of the conventional material for the partitions. Material for a partition protective layer is prepared (S820), as shown in FIG. 9J, the material for the partition protective layer is coated on the partitions (S830) and is baked (S840), and phosphor 814 is coated as shown in FIG. 9K to complete a rear substrate. The material for the partition protective layer includes a solvent, binders, dispersant, and inorganic ion exchangers, and details of components and compositions thereof are identical to those of the material for the partition protect layer of the plasma display panel as described above, and preferably, is coated by a spray method. Preferably, baking temperature is 500 degrees centigrade to 600 degrees centigrade, and more preferably, 540 degrees centigrade to 560 degrees centigrade.

The rear substrate manufactured by the above-described process is bonded to the front substrate and inert gas such as helium gas He, Neon gas Ne, Xenon gas Xe, or the like is injected thereinto to complete the plasma display panel.

In the methods of manufacturing a plasma display panel according to the first and second preferred embodiments of the present invention, the inorganic ion exchangers are added to the partitions or the surfaces of the partitions. Thus, when the material for the partitions is baked at 500 degrees centigrade to 600 degrees centigrade in the baking of the partitions, the inorganic ion exchangers capture Na⁺ so that the quantity of Na reacting with Ag is reduced. As a result, the quantity of Ag⁺ reduced into Ag⁺ decreases to prevent the yellow discoloration so that color temperature of the white ray of the plasma display panel may be improved and light permeability may be also improved.

Moreover, when the front glass or the rear glass includes the inorganic ion exchangers, the yellow discoloration is prevented so that optical characteristics and external appearance of the plasma display panel may be enhanced. Particularly, since the content of Na of the soda-lime glass is very high, about three times PD200, thereby causing the yellow discoloration to be significantly generated, it is preferred to use the inorganic ion exchangers.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A plasma display panel comprising:
an upper plate having a sustain electrode;
a lower plate having an address electrode; and
a partition formed between the upper plate and the lower plate and having an inorganic ion exchanger.

2. The plasma display panel as set forth in claim 1, wherein the inorganic ion exchanger comprises at least one of aluminosilicate, hydrous metal oxide, acid salt, and heteropolic acid.

3. The plasma display panel as set forth in claim 2, wherein the aluminosilicate comprises zeolite.

4. The plasma display panel as set forth in claim 2, wherein the hydrous metal oxide comprises at least one of Sb₂O₅.2H₂O and Bi₂O₃.3H₂O.

5. The plasma display panel as set forth in claim 2, wherein the acid salt comprises at least one of Zr(HPO₄)₂.H₂O and Ti(HPO₄)₂.H₂O.

6. The plasma display panel as set forth in claim 2, wherein the heteropolic acid comprises (NH₄)₃Mo₁₂(PO₄)₄₀.nH₂O.

7. The plasma display panel as set forth in claim 1 wherein the inorganic ion exchanger comprises at least one of Ca₁₀(PO₄)₆(OH)₂ and MgCl(CO₃)(OH).nH₂O.

8. The plasma display panel as set forth in claim 1, wherein the inorganic ion exchanger has a weight ratio of 0.01% to 5.0% within the partition.

9. The plasma display panel as set forth in claim 1, wherein the partition further comprises inorganic powder having a weight ratio of 95% to 99.99%.

10. The plasma display panel as set forth in claim 9, wherein the inorganic powder comprises a glass having a weight ratio of 50% to 70% and a filler having a weight ratio of 30% to 50%.

11. The plasma display panel as set forth in claim 10, wherein the filler comprises at least one of PbO, ZnO, Al₂O₃, and TiO₂.

12. The plasma display panel as set forth in claim 1, wherein the inorganic ion exchanger is formed as a layer formed on the surface of the partition.

13. A method of manufacturing a plasma display panel comprising the steps of:
(1) preparing a material for a partition including an inorganic powder having a weight ratio of 60% to 80% and a vehicle having a weight ratio of 20% to 40% and an inorganic ion exchanger having a weight ratio of 0.01% to 5%; and
(2) forming the partition on a lower plate using the material for the partition.

14. The method of manufacturing a plasma display panel as set forth in claim 13, wherein the material for the partition is made in a form of a paste or a green sheet.

15. The method of manufacturing a plasma display panel as set forth in claim 13, wherein the step (2) comprises the sub-steps of:
(a) coating the material for the partition on a dielectric material of the lower plate;
(b) exposing and developing the material for the partition; and
(c) baking the material for the partition.

16. The method of manufacturing a plasma display panel as set forth in claim 15, wherein, during the sub-step (a), on the dielectric material of the lower plate, a green sheet for the partition is laminated, a paste for the partition is coated, or the paste for the partition is printed.

17. A method of manufacturing a plasma display panel comprising the steps of:
forming a partition including a glass having inorganic powder on a dielectric material of a lower plate; and
forming a partition protective layer on the surface of the partition using a material including a solvent having a weight ratio of 80% to 95%, a binder having a weight ratio of 5% to 20%, a dispersant having a weight ratio of 0.1% to 1%, and an inorganic ion exchanger having a weight ratio of 0.01% to 5%.

18. A composition of a material for a partition of a plasma display panel comprising:
an inorganic powder having a weight ratio of 60% to 80%;
a vehicle having a weight ratio of 20% to 40%; and
an inorganic ion exchanger having a weight ratio of 0.01% to 5%.

19. The composition of a material for a partition of a plasma display panel as set forth in claim 18, wherein the inorganic powder comprises:
a glass having a weight ratio of 50% to 70%; and
a filler having a weight ratio of 30% to 50%.

20. The composition of a material for a partition of a plasma display panel as set forth in claim 19, wherein the filler comprises at least one of PbO, ZnO, Al₂O₃, and TiO₂.

21. The composition of a material for a partition of a plasma display panel as set forth in claim 18, wherein the vehicle comprises a binder and a solvent.

22. The composition of a material for a partition of a plasma display panel as set forth in claim 18, wherein the inorganic ion exchanger comprises at least one of aluminosilicate, hydrous metal oxide, acid salt, and heteropolic acid.

23. The composition of a material for a partition of a plasma display panel as set forth in claim 22, wherein the aluminosilicate comprises zeolite.

24. The composition of a material for a partition of a plasma display panel as set forth in claim 22, wherein the hydrous metal oxide comprises at least one of Sb₂O₅.2H₂O and Bi₂O₃.3H₂O.

25. The composition of a material for a partition of a plasma display panel as set forth in claim 22, wherein the acid salt comprises at least one of Zr(HPO₄)₂.H₂O and Ti(HPO₄)₂.H₂O.

26. The composition of a material for a partition of a plasma display panel as set forth in claim 22, wherein the heteropolic acid comprises (NH₄)₃Mo₁₂(PO₄)₄₀.nH₂O.

27. The composition of a material for a partition of a plasma display panel as set forth in claim 18, wherein the inorganic ion exchanger comprises at least one of Ca₁₀(PO₄)₆(OH)₂ and MgCl(CO₃)(OH).nH₂O.

28. The plasma display panel as set forth in claim 3, wherein the inorganic ion exchanger comprises at least one of Ca10(PO4)6(OH)2 and MgCl(CO3)(OH).nH2O.
